(19) United States
(12) Patent Application Publication
(10) Pub. No.: US 2021/0213773 A1
(43) Pub. Date: Jul. 15, 2021

(54) CLOSURE CAP FOR WRITING AND DRAWING INSTRUMENTS

(71) Applicant: Inigo ECHEVERRIA MARTINEZ, SAN SEBASTIAN (GIPUZKOA) (ES)

(72) Inventor: Inigo ECHEVERRIA MARTINEZ, SAN SEBASTIAN (GIPUZKOA) (ES)

(21) Appl. No.: 15/734,154

(22) PCT Filed: May 30, 2019
(86) PCT No.: PCT/ES2019/070361

§ 371 Date: Dec. 1, 2020

(30) Foreign Application Priority Data
Jun. 1, 2018 (ES) U201830822

(51) Int. Cl. B43K 23/12; B43K 29/00

(52) U.S. Cl. CPC B43K 23/12; B43K 29/00

(57) ABSTRACT

A closure cap for writing and drawing instruments is provided having a tubular element intended for covering an ink-application element of a writing instrument when same is not in use, with a housing being defined in the tubular element which is intended for containing a volatile liquid, with said housing remaining in communication with the hollow interior of the tubular element via, at least, one opening, with the closure of said communication occurring by an impermeable and breathable membrane.

### TECHNICAL FIELD

The present invention relates to writing and drawing instruments, such as fountain pens, stylographs, felt-tip pens and generally any writing instrument using a liquid or ink as the writing medium, proposing a closure cap for said instruments in which there has been provided an arrangement which prevents the ink from drying out, including ink known as Indian ink, in the application element when same is closed and not in use so that it may be stored or transported, thereby improving the use qualities of said writing and drawing instrument for the practical application usage thereof.

### STATE OF THE ART

For the sake of simple comprehension and description, fountain pens shall be referred to hereinafter, where said reference must be understood as extending to all writing and drawing instruments indicated in the preceding paragraph and never in a limiting sense. Fountain pens are writing instruments which have an ink reservoir in communication with an application element whereby the ink spreads over an application surface following the line drawn by the user, said pens comprising a closure cap for protecting the ink-application element when the pen is not in use.

The closure cap of fountain pens is a hollow element coupled onto the end of the pen for covering the ink-application element, where said cap may be secured to the pen by means of a threaded coupling or a press fit coupling.

In either case, the incorporation of the closure cap on the corresponding fountain pen ensures protection of the ink-application element, but it does not prevent the residual ink in the application element from drying up, therefore when the pen is going to be used after it has been idle for some time, the application element must be cleaned so as to remove the dry ink, since the dry ink clogs the outlet of the flow of ink through the application element for the deposition thereof on the application surface.

It is therefore necessary to prevent the residual ink remaining in the application element of fountain pens from drying out when said pens are left with the closure cap incorporated thereon in order to facilitate reusing said pens when desired.

### OBJECT OF THE INVENTION

According to the invention, there is proposed a closure cap for writing and drawing instruments, which has been developed with certain constructive and functional features that efficiently prevent the residual ink in the ink-application element from drying out when the writing instrument is closed with the cap incorporated thereon.

The cap object of the invention consists of a hollow tubular element open at one end and provided at the other end with a housing intended for containing a volatile liquid, with said housing being in communication with the hollow interior of the cap via, at least, one opening, including in said communication an impermeable and breathable membrane.

The communication between the housing containing the volatile liquid and the hollow interior of the cap is thereby closed by the impermeable and breathable membrane, which keeps the volatile liquid confined to the housing containing same, since said membrane does not allow the passage of liquid therethrough, but it does allow the passage of the gas phase resulting from the evaporation of the volatile liquid, with moisture passing up to the hollow interior of the cap, wherein the ink-application element is housed when the corresponding writing instrument is closed with the cap.

The ink-application element belonging to the writing instrument is thereby maintained in wet conditions which prevent the residual ink found in said application element from drying out when the writing instrument is closed with the cap, which, when the writing instrument is to be used again, allows same to be in perfect conditions for the outlet of the ink through the application element so as to spread same over the application surface.

The housing for containing the volatile liquid in the closure cap of writing instruments according to the invention can be determined by means of any embodiment which allows the wetting function of the ink-application element as indicated, said housing being formed, for example, by means of an accessory ferrule incorporated in the cap, by means of a removable portion of the cap closed with a cover, or by means of a constructive one-piece formation of the cap, all solutions of which are encompassed in the scope of the invention.

The membrane preferably comprises a configuration reciprocal to the configuration of the ink-application element, such that the membrane surrounds the ink-application element, causing the evaporated gas of the volatile liquid to more efficiently surround and wet said ink-application element.

With all this, the cap object of the invention has very advantageous features for the application of closing the writing instruments for which it is intended, acquiring its own identity and preferred character with respect to conventional caps having that function.

### DESCRIPTION OF THE FIGURES

FIG. 1 shows a longitudinal cross-sectional view of a writing instrument closed with a cap performed according to the invention.

FIG. 2 is an enlarged detail of the portion of the cap in which the housing for the volatile liquid is located, according to an exemplary embodiment.

FIG. 3 is a detail similar to that of the preceding figure, according to another exemplary embodiment for determining the housing of the volatile liquid in the cap.

FIG. 4 is another exemplary embodiment for determining the housing of the volatile liquid in the cap.

FIG. 5 is a detail of another exemplary embodiment for determining the housing for the volatile liquid.

FIG. 6 is a detail view in which a membrane has a configuration adapted to the configuration of an ink-application element.

### DETAILED DESCRIPTION OF THE INVENTION

The object of the invention relates to a closure cap for writing instruments (1), intended for being incorporated as a cover to protect the ink-application element (2) in the corresponding writing instrument (1) when same is not in use, comprising a tubular element (3) open at one end where there is determined a coupling (4), which can be a threaded or press fit coupling, for being secured to the writing instrument (1) of application.

At the end opposite the coupling (4), the tubular element (3) is closed and there is defined at said end a housing (5) intended for containing a volatile liquid at room temperature, such as water for example, with said housing (5) remaining in communication with the hollow interior of the tubular element (3) via, at least, one opening, with the closure of said communication occurring by means of an impermeable and breathable membrane (6), in other words, it allows the passage therethrough of a gas but does not allow a liquid to go through it.

Said closure membrane (6) between the housing (5) and the hollow interior of the tubular element (3) is provided, for example, with a material such as expanded polytetrafluoroethylene (ePTFE), which suitably fulfils the mentioned specifications of allowing a gas to go through it but not a liquid.

With that being the case, the volatile liquid contained in the housing (5) is retained in said housing (5) without being able to pass into the hollow interior of the tubular element (3), since this is prevented by the membrane (6), but the gas phase resulting from the evaporation of said volatile liquid is allowed to pass through the membrane (6), creating a wetness in the mentioned hollow interior of the tubular element (3).

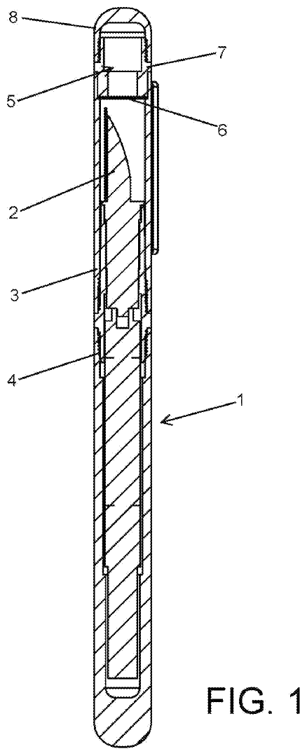

Therefore, when the closure cap is coupled on the corresponding writing instrument (1), with the ink-application element (2) being housed in the hollow interior of the tubular element (3), as observed in FIG. 1, said ink-application element (2) of the writing instrument (1) is maintained in a wet environment due to the vaporised gas passing through the membrane (6) from the housing (5) to the mentioned hollow interior of the tubular element (3), where the ink-application element (2) is located, which prevents the residual ink remaining in that ink-application element (2) from drying out after using the writing instrument (1), with the ink passage fluidity through said ink-application element (2) thus being maintained for reusing the writing instrument (1) without problems.

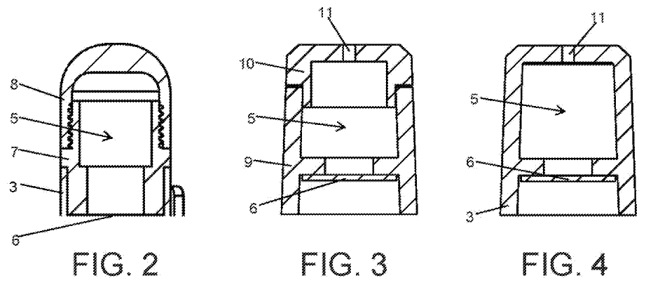

For that purpose, the housing (5) intended for containing the volatile liquid in the closure cap of the writing instruments (1) can be determined in any manner in the constructive structuring of the cap of application, for example, as observed in FIG. 2, by means of an accessory ferrule (7) incorporated at the end of the tubular element (3), with the closure of said ferrule (7) occurring by means of a removable cover (8).

According to another exemplary embodiment, the housing (5) for the volatile liquid can also be determined, as shown in FIG. 3, by means of a segment (9) which is removably coupled at the end of the tubular element (3), there being defined in the segment (9) a hollow portion closed with a cover (10), in which there may be a filling valve (11) for introducing the volatile liquid.

In a general embodiment concept, the housing (5) may in turn be determined, according to the example of FIG. 4, by means of a one-piece formation of the cap, configuring in the actual constructive formation of the tubular element (3) a hollow portion determining the housing (5), with a filling valve (11) in communication with said hollow portion for introducing the volatile liquid.

The filling valve (11) can be a simple membrane or an elastomeric element which allows the passage therethrough of a syringe-type liquid loading element, such that when the loading element is removed, the membrane closes off the passage of liquid, preventing its unwanted exit.

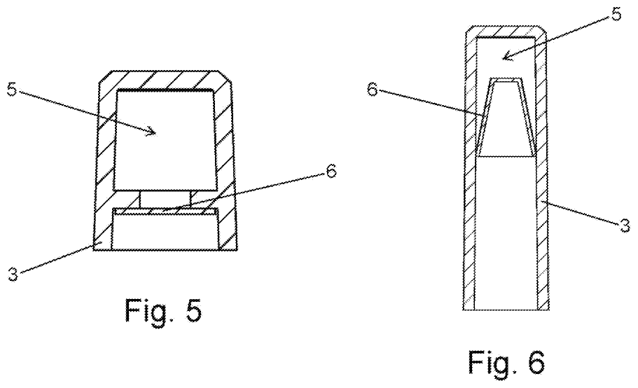

Likewise, according to another exemplary embodiment shown in FIG. 5, the housing (5) could be determined by means of a one-piece formation of the cap, configuring in the actual constructive formation of the tubular element (3) a hollow portion determining the housing (5). However, this embodiment does not provide for any element which allows the filling of the housing (5) with volatile liquid, such that when said volatile liquid is used up in its entirety, the cap will no longer be able to wet the ink-application element (2).

As can be seen in FIG. 6, the membrane (6) preferably comprises a configuration reciprocal to the configuration of the ink-application element (2), such that the membrane (6) surrounds the ink-application element (2), causing a better wetting effect on said ink-application element (2).

1. A closure cap for writing and drawing instruments, comprising a tubular element intended for covering an ink-application element of a writing instrument when same is not in use, a housing intended for containing a volatile liquid is defined in the tubular element, with said housing remaining in communication with the hollow interior of the tubular element via, at least, one opening, with the closure of said communication occurring by means of an impermeable and breathable membrane.

2. The closure cap for writing and drawing instruments according to claim 1, wherein the impermeable and breathable membrane is made of expanded polytetrafluoroethylene (ePTFE).

3. The closure cap for writing and drawing instruments according to claim 1, wherein the housing is determined by means of an accessory ferrule incorporated at the end of the tubular element, with the closure of said ferrule occurring by means of a removable cover.

4. The closure cap for writing and drawing instruments according to claim 1, wherein the housing is determined by means of a segment which is removably coupled at the end of the tubular element, a hollow portion closed with a cover provided with a filling valve being defined in the segment.

5. The closure cap for writing and drawing instruments according to claim 1, wherein the housing is determined by means of a hollow portion defined in a one-piece formation of the tubular element.

6. The closure cap for writing and drawing instruments according to claim 1, comprising a filling valve in communication with the housing.

7. The closure cap for writing and drawing instruments according to claim 1, wherein the membrane has a configuration reciprocal to the configuration of the ink-application element.
